(19) United States
(12) Patent Application Publication
(10) Pub. No.: US 2011/0056328 A1
(43) Pub. Date: Mar. 10, 2011

(54) Strengthening structure of plastic casing of elevating motor

(76) Inventor: Chen-Hui Ko, Koeishan Hsiang (TW)

(21) Appl. No.: 12/585,264

(22) Filed: Sep. 10, 2009

(51) Int. Cl. F16H 57/02

(52) U.S. Cl. 74/606 R

(57) ABSTRACT

The present invention discloses a strengthening structure of a plastic casing of an elevating motor, and the casing of a transmission gear box of the elevating motor includes a front casing and a rear casing, both made of a light-weight plastic material, and a metal reinforced plate installed at a position of the casing with maximum exerted propping force and torque and perpendicular to a bushing to form a rigid support structure for propping and supporting the casing, such that a load can be supported uniformly by the whole piece of the metal reinforced plate to overcome the problem of cracking a contact surface easily in the prior art, and achieve the effects of reducing the overall weight, maintaining the mechanical strength, extending the using life and providing a smooth transmission.

### BACKGROUND OF THE INVENTION

1. Field of the Invention

The present invention relates to an elevating motor, in particular to an elevating motor having a casing made of a plastic material, and a metal reinforced plate installed at a major force exerting position, such that the overall weight and strength of the elevating motor can meet an expected requirement.

2. Description of the Related Art

In fitness equipments or rehabilitation equipments, an elevating motor is usually used for adjusting the angle of inclination or angle of elevation of a machine body to facilitate users to use the equipments. At present, most elevating motors of this sort use a motor as a power source and a speed reduction gear box for driving an elevating element to rotate in order to adjust the equipments to a required angle.

With reference to FIG. 1 for a schematic view of a conventional elevating motor of a treadmill, the elevating motor 20 of the treadmill 10 comprises a motor 21, a speed reduction gear box 22 pivotally installed onto a base 11 for driving a threaded rod 23 that serves as a propping element to ascend or descend the elevating motor 20, such that the threaded rod 23 can be extended or retreated inside a long tubular bushing 24 with its bottom pivotally coupled to a seat 12. Such elevating machine is characterized in that the threaded rod 23 is ascended or descended to adjust the height above the bushing 24 for ascending or descending the base 11.

However, the conventional speed reduction gear boxes 22 are generally casted with a high-strength metal, but the overall weight of the metal is very heavy and unfavorable for installing and transporting the treadmill. Furthermore, the whole gear box 22 is made of the high-strength metal, not only increasing the weight, but also incurring a high cost, and both are unfavorable to industrial applications.

In view of the foregoing shortcomings of the prior art, the inventor of the present invention based on years of experience in the related industry to conduct extensive researches and experiments, and finally developed a transmission gear box 22 made of a plastic material to overcome the aforementioned shortcomings. When the threaded rod 23 is driven by a transmission gear and a screw insert (not shown in the figure) inside the gear box 22 to ascend or descend axially, forces are concentrated at a periphery 221 of the gear box casing 22 which is in contact with the threaded rod 23 and the bushing 24, and thus the periphery 221 may be cracked easily and frequently, resulting in a failure or a damage of the elevating motor 20.

Although the inventor of the present invention has designed a gear box casing previously, and a half of the gear box casing is made a plastic material, and another half of the gear box casing is made of a metal material to achieve the effect of providing the required overall weight and strength. Since the length of axial action of the threaded rod 23 and the bushing 24 of the elevating motor 20 is relatively long, the moment with respect to the arm of force is relatively large, and the torque so produced is concentrated at front and rear sides of the gear box casing 22, particularly at a position where the bushing 24 and the gear box casing 22 are connected. As a result, a crack may occur at the connecting position frequently, and thus the prior art requires further improvements.

### SUMMARY OF THE INVENTION

A primary object of the present invention is to provide a strengthening structure of a plastic casing of an elevating motor, and the structure is capable of reducing the overall weight and maintaining the mechanical strength of the casing of the elevating motor.

Another object of the present invention is to provide a strengthening structure of a plastic casing of an elevating motor, and the structure includes a metal reinforced plate installed at a position having the maximum propping force and torque produced by the elevating motor and provided for perpendicularly supporting the bushing to form a rigid support structure, such that a bearing force can be supported uniformly by the whole metal reinforced plate to overcome the shortcoming of the prior art that a crack may occur at the contact surface easily, so as to achieve the effect of providing a long using life and a smooth transmission.

In order to achieve the above-mentioned objects, a strengthening structure of a plastic casing of an elevating motor in accordance with the invention includes:

a) a casing, having a front casing and a rear casing, engaged with each other by a plurality of bolts, and the front and rear casings being made of a plastic material, and a first through hole and a second through hole being formed coaxially at front and rear sides, and the front and rear casings having a first circular recession and a second circular recession formed on internal sides the periphery of the first and second through holes respectively;

b) a transmission unit, installed in the casing, and comprising a transmission gear, a speed reduction gear, a screw insert formed at the middle of the transmission gear, and first and second cam shafts formed at front and rear portions of the screw insert and sheathed into the first and second circular recessions respectively;

c) a motor, installed outside the casing, for providing a motive power to the transmission unit;

d) a threaded rod, passed through the first and second through holes of the casing, and engaged with the screw insert of the transmission gear; and

e) a metal bushing, installed outside the front casing, and sheathed onto an end of the threaded rod, and having a first pipe opening formed at the front casing first through hole, a first metal reinforced plate mounted at the periphery of the first pipe opening and coupled perpendicularly with the front casing, and a first locking hole formed at the first metal reinforced plate and secured to one of the corresponding bolts of the front and rear casings, such that the first metal reinforced plate is fixed securely to the front casing to improve the strength at a force exerting position of the casing.

According to the invention, one or more additional metal reinforced plates is provided to create a sufficient strength to meet a standard requirement while minimizing the weight, so as to provide a convenient way of operating a fitness equipment such as a treadmill.

### BRIEF DESCRIPTION OF THE FIGURES

FIG. 1 is a schematic view of a conventional elevating motor of a treadmill;

FIG. 2 is an exploded view of a first preferred embodiment of the present invention;

FIG. 3 is a perspective view of a first preferred embodiment of the present invention;

FIG. 4 is a cross-sectional view of a first preferred embodiment of the present invention;

FIG. 5 is a perspective view of a reinforced body in accordance with a second preferred embodiment of the present invention;

FIG. 6 is a perspective view of a second preferred embodiment of the present invention;

FIG. 7 is a cross-sectional view of a second preferred embodiment of the present invention;

FIG. 8 is a perspective view of a reinforced body in accordance with a third preferred embodiment of the present invention; and

FIG. 9 is a perspective view of a third preferred embodiment of the present invention.

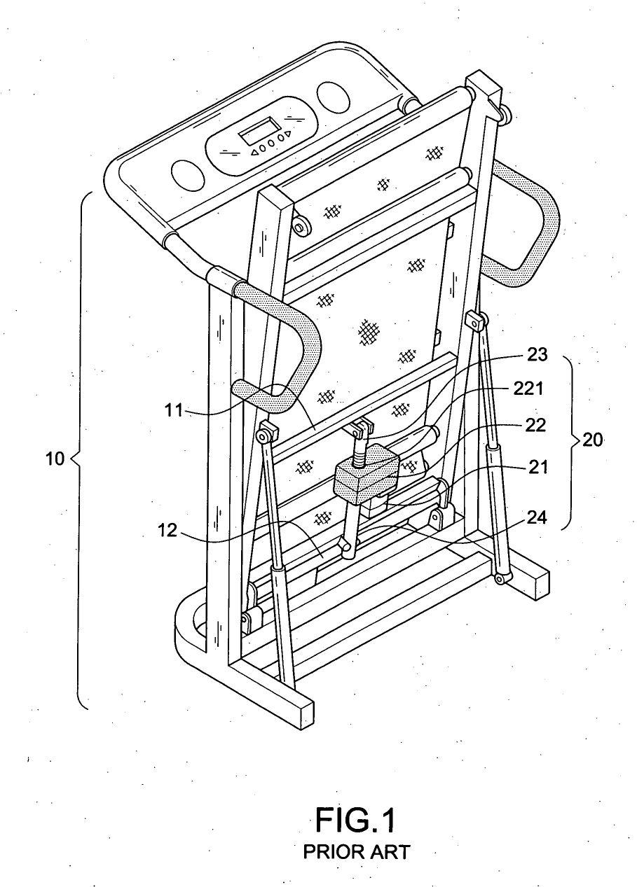

### DETAILED DESCRIPTION OF THE PREFERRED EMBODIMENT

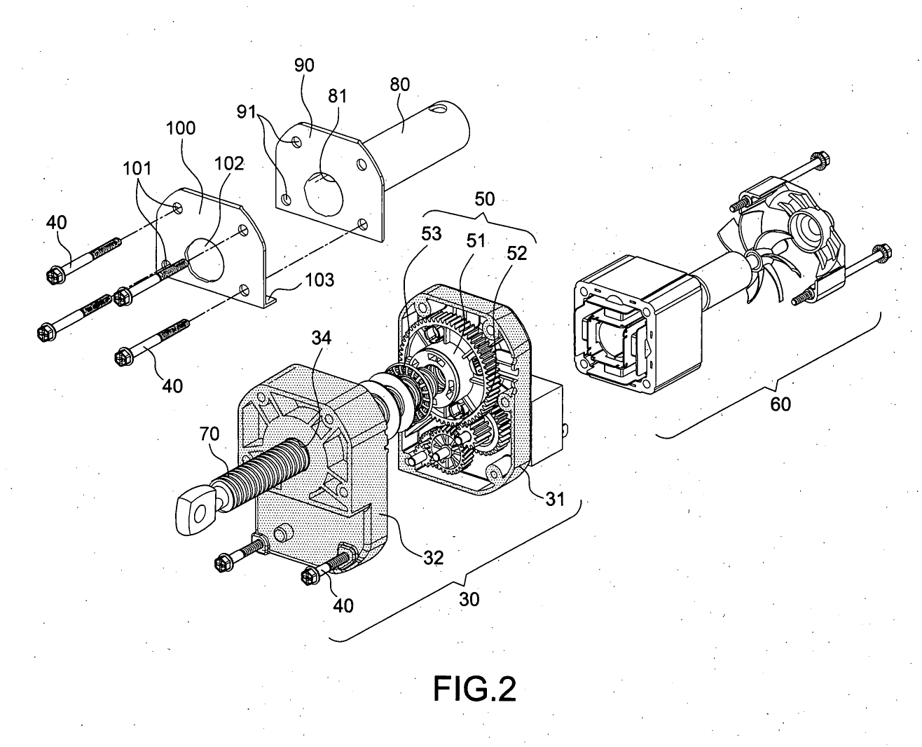

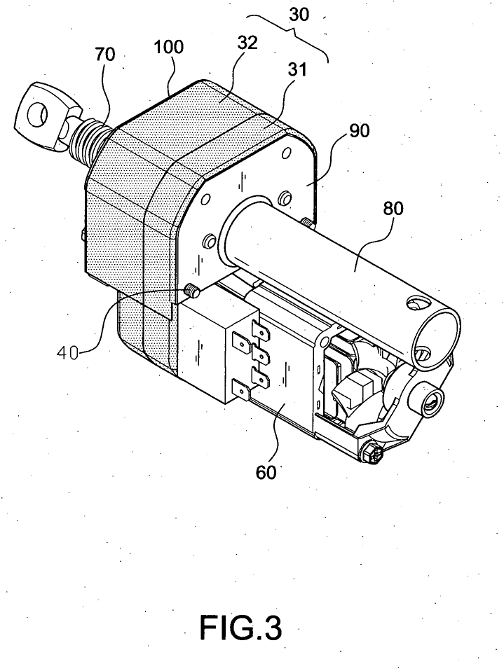

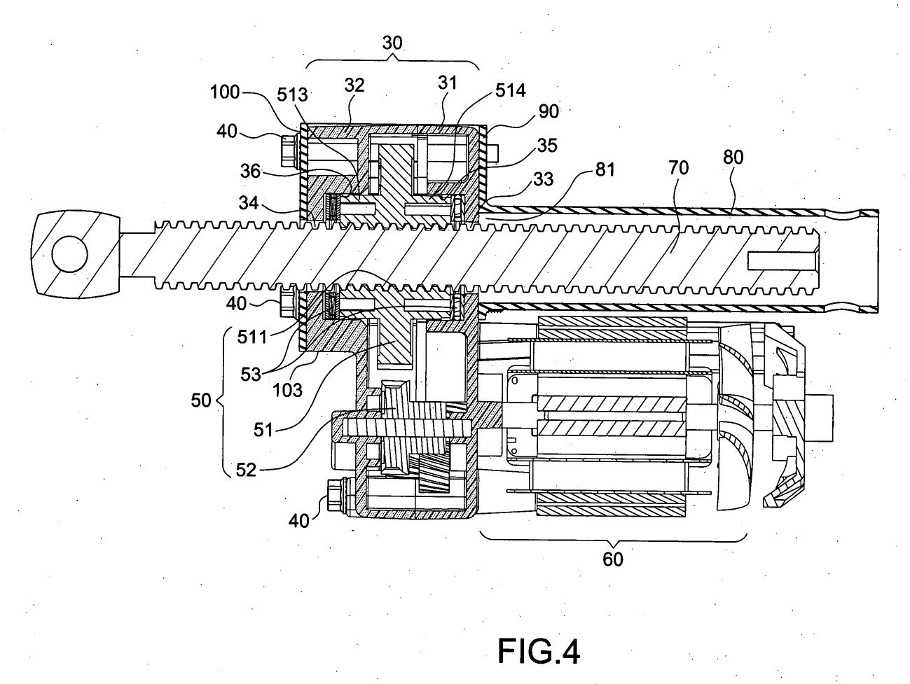

With reference to FIGS. 2 to 4 for a preferred embodiment of the present invention, the invention comprises:

a casing 30, having a front casing 31 and a rear casing 32 engaged with each other by a plurality of bolts 40, and the front and rear casings 31, 32 being made of a plastic material, and a first through hole 33 and a second through hole 34 formed coaxially at front and rear sides of the casing 30, and the front and rear casings 31, 32 including a first circular recession 35 and a second circular recession 36 disposed on internal sides of the periphery of the first and second through holes 33, 34;

a transmission unit 50, installed in the casing 30, and comprising a transmission gear 51, a speed reduction gear 52, a screw insert 511 formed at the middle of the transmission gear 51, and first and second cam shafts 513, 514 formed at front and rear portions of the screw insert 511 and sheathed into the first and second circular recessions 35, 36 respectively;

a motor 64, installed outside the casing 30, for providing a motive power to the transmission unit 50;

a threaded rod 70, passed through the first and second through holes 33, 34 of the casing, and engaged with a screw insert 511 of the transmission gear 51; and

a metal bushing 80, disposed outside the front casing 31 and sheathed onto an end of the threaded rod 70, and the bushing 80 having a first pipe opening 81 formed at the first through hole 33 of the front casing 31, a first metal reinforced plate 90 fixed onto the periphery of the first pipe opening and coupled perpendicularly with the front casing 31, and a plurality of bolts 40 of the first metal reinforced plate 91 provided for securing the front and rear casings 31, 32 having a first locking hole 91, such that the first metal reinforced plate 90 is coupled to the front casing 31 securely to improve the strength at the force exerting position of the casing 30.

Based on the aforementioned structure, the present invention comprises a first metal reinforced plate 90 installed at the periphery of the first pipe opening 81 of the metal bushing 80 and at a larger force exerting position for providing a support action and preventing the force from concentrating at a point. During the process of propping the elevating motor, the connecting position of the metal bushing 80 and threaded rod 70 with the casing 30 is an action point having the maximum force exerted. The first metal reinforced plate 90 of the present invention is attached onto the front casing 31, and a bolt 40 is provided for connecting the front casing 31 to form a rigid support structure, whose mechanical strength is not inferior to a metal cast casing, and then the metal bushing 80 is coupled securely onto the front side of the casing. In addition, the metal cast casing generally comes with a weight of 10 kg, and the plastic casing 30 of the invention has a weight of 1 kg only, and the total weight including the weight of the first metal reinforced plate 90 will not exceed 2 kg. Obviously, the present invention can achieve the effect of reducing the weight effectively. Since the invention provides a rigid support structure for bearing a larger action force precisely at the position having the larger exerted force, therefore the overall mechanical strength can meet the desired requirement and optimize the weight and strength of the casing.

In addition, the first metal reinforced plate 90 of the metal bushing 80 is integrated formed with the front casing 31 (not shown in the figure). In other words, the first metal reinforced plate 90 is integrated with a side of the front casing 31 to provide a more secured structure.

The present invention further comprises an axial bearing 53 installed onto an axial contact surface of the first and second circular recessions 35, 36 and the first and second cam shafts 513, 514, and the axial bearing 53 is a plummer block bearing, a needle roller bearing or a ball bearing, etc.

To enhance the strength, a preferred embodiment of the present invention further comprises a second metal reinforced plate 100 installed onto an external side of the rear casing 32 for passing the threaded rod 70, and the second metal reinforced plate 100 includes a third through hole 102 for passing the threaded rod 70, and a plurality of second locking holes 101 formed at the periphery of the third through hole 102 for passing and coupling the bolts 40, and a folded edge 103 is formed at the bottom of the second metal reinforced plate 100 and corresponding to a protruding shape of the rear casing 32 to constitute a L-shaped body, such that the first and second metal reinforced plates 90, 100 can wrap and clamp both front and rear sides of the casing 30 to improve the bearing strength. In other words, the structure is similar to a sandwich structure that uses the bolts 40 secured in an axial direction for the connection to form a rigid support structure.

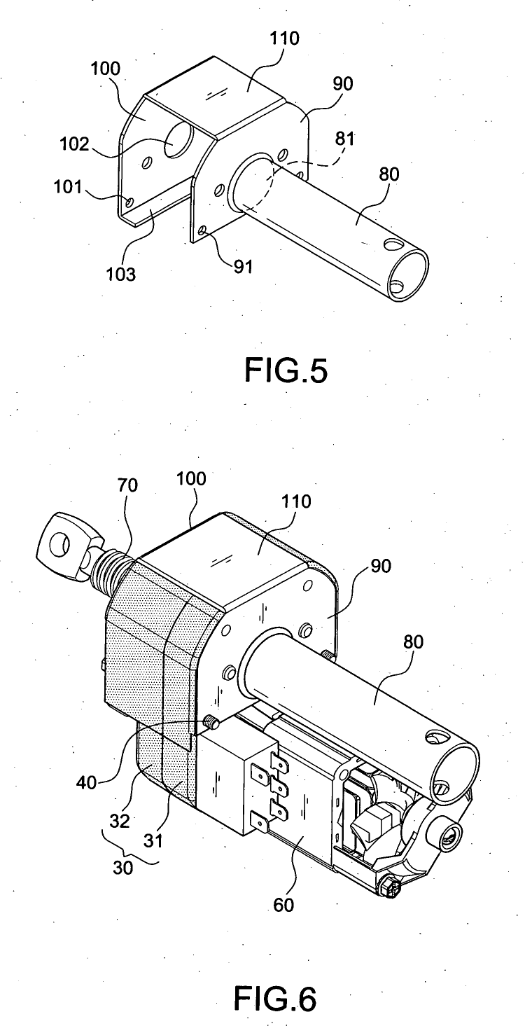

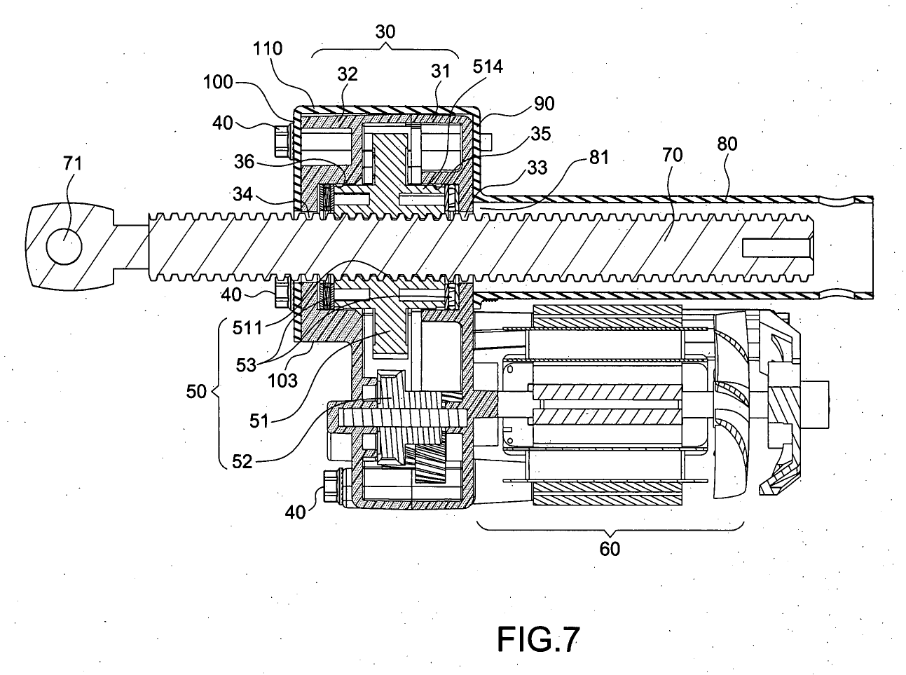

With reference to FIGS. 5 to 7 for another preferred embodiment of the present invention, the structure of this embodiment is similar to the aforementioned preferred embodiment and related elements are represented by their respective numerals, and the difference of this preferred embodiment from the aforementioned preferred embodiment resides on that a third metal reinforced plate 110 is installed between the second metal reinforced plate 100 and the first metal reinforced plate 90 and coupled to a side of the casing to form an n-shaped reinforced body for wrapping and clamping three sides of the casing 30.

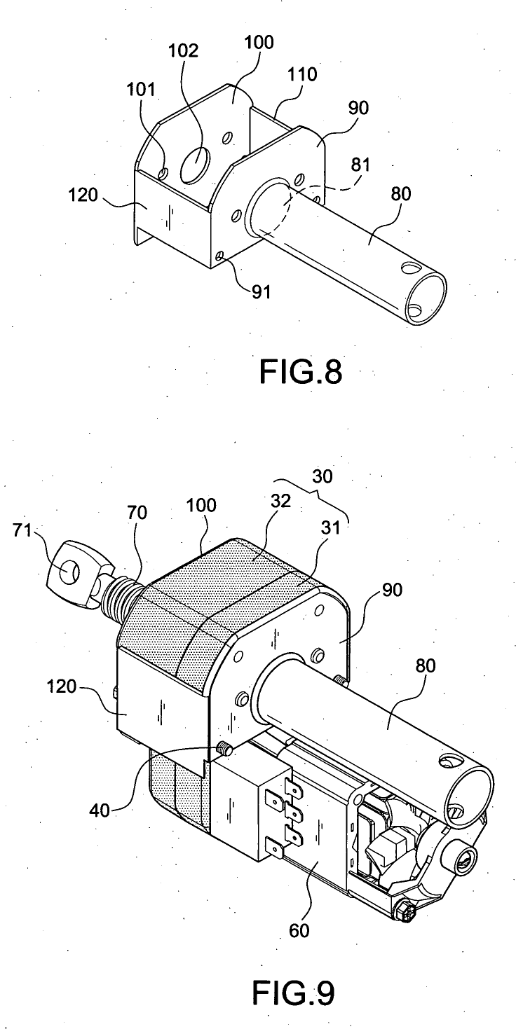

With reference to FIGS. 8 and 9 for a further preferred embodiment of the present invention, the structure of this embodiment is similar to the aforementioned preferred embodiments and related elements are represented by their respective numerals, and the difference of this preferred embodiment from the aforementioned two preferred embodiments resides on that this embodiment of the invention further comprises third and fourth metal reinforced plates 110, 120 installed between the second metal reinforced plate 100 and the first metal reinforced plate 90 and coupled to both symmetric sides of the casing to form a square reinforced body for wrapping and clamping four sides of the casing 30.

In summation of the description above, the present invention provides a lightweight casing made of a plastic material and comprises a metal reinforced plate installed perpendicularly to the metal bushing or further comprises one or more additional metal reinforced plates to provide sufficient strength to meet a standard requirement while minimizing the weight, so as to provide a convenient way of operating a fitness equipment such as a treadmill.

Many changes and modifications in the above-described embodiments of the invention can, of course, be carried out without departing from the scope thereof. Accordingly, to promote the progress in science and the useful arts, the invention is disclosed and is intended to be limited only by the scope of the appended claims.

What is claimed is:

1. A strengthening structure of a plastic casing of an elevating motor, comprising:
a) a casing, having a front casing and a rear casing, engaged with each other by a plurality of bolts, and the front and rear casings being made of a plastic material, and a first through hole and a second through hole being formed coaxially at front and rear sides, and the front and rear casings having a first circular recession and a second circular recession formed on internal sides the periphery of the first and second through holes respectively;
b) a transmission unit, installed in the casing, and comprising a transmission gear, a speed reduction gear, a screw insert formed at the middle of the transmission gear, and first and second cam shafts formed at front and rear portions of the screw insert and sheathed into the first and second circular recessions respectively;
c) a motor, installed outside the casing, for providing a motive power to the transmission unit;
d) a threaded rod, passed through the first and second through holes of the casing, and engaged with the screw insert of the transmission gear; and
e) a metal bushing, installed outside the front casing, and sheathed onto an end of the threaded rod, and having a first pipe opening formed at the front casing first through hole, a first metal reinforced plate mounted at the periphery of the first pipe opening and coupled perpendicularly with the front casing, and a first locking hole formed at the first metal reinforced plate and secured to one of the corresponding bolts of the front and rear casings, such that the first metal reinforced plate is fixed securely to the front casing to improve the strength at a force exerting position of the casing.

2. The strengthening structure of a plastic casing of an elevating motor as recited in claim 1, wherein the first metal reinforced plate of the metal bushing is integrally formed with the front casing.

3. The strengthening structure of a plastic casing of an elevating motor as recited in claim 1, further comprising an axial bearing installed separately at an axial contact surface of the first and second circular recessions and an axial contact surface of the first and second cam shafts.

4. The strengthening structure of a plastic casing of an elevating motor as recited in claim 1, wherein the rear casing includes a second metal reinforced plate installed onto an external side of the rear casing for passing the threaded rod, and the second metal reinforced plate includes a third through hole for passing the threaded rod, and a plurality of second locking holes formed around the periphery of the third through hole for coupling the bolts, and the second metal reinforced plate having a folded edge formed at the bottom of the second metal reinforced plate and corresponding to a protruding shape of the rear casing to form an L-shaped body, such that the first and second metal reinforced plates wrap and clamp both front and rear sides of the casing to improve a bearing strength.

5. The strengthening structure of a plastic casing of an elevating motor as recited in claim 3, further comprising a third metal reinforced plate installed between the second metal reinforced plate and the first metal reinforced plate and connected to a side of the casing to form an n-shaped reinforced body for wrapping and clamping three sides of the casing.

6. The strengthening structure of a plastic casing of an elevating motor as recited in claim 4, further comprising a third metal reinforced plate and a fourth metal reinforced plate installed between the second metal reinforced plate and the first metal reinforced plate and connected to two symmetric sides of the casing to form a square reinforced body for wrapping and clamping fours sides of the casing.
